(19) United States
(12) Patent Application Publication
(10) Pub. No.: US 2019/0329448 A1
(43) Pub. Date: Oct. 31, 2019

(54) SYSTEM AND METHOD FOR MANUFACTURING GYPSUM BOARDS WITH ONLINE LUMP DETECTION

(71) Applicant: United States Gypsum Company, Chicago, IL (US)

(72) Inventors: Russell DAVIS, Sweetwater, TX (US); Rick L. ADAMS, Sweetwater, TX (US)

(21) Appl. No.: 15/962,845

(22) Filed: Apr. 25, 2018

(51) Int. Cl. B28B 17/00; B28B 5/02; B28B 3/12

(52) U.S. Cl. CPC B28B 17/0081; B28B 3/123; B28B 5/027

(57) ABSTRACT

Embodiments of a system and a method for manufacturing a gypsum board include a forming assembly configured to form the gypsum board to be within a predetermined thickness range and to detect vibration at the forming assembly during the continuous manufacture of gypsum board that is indicative of a hardened lump of slurry that may cause manufacturing process problems being lodged at or passing through the forming assembly. The forming assembly includes first and second forming members, an actuator, a vibration sensor, and a controller. The vibration sensor is arranged with respect to one of the first and second forming members to detect the vibration of said forming member. The controller is programmed to control the actuator to increase the height between the second forming member and the first forming member by a predetermined amount in response to the vibration signal from the vibration sensor satisfying a condition.

### BACKGROUND

The present disclosure relates to continuous gypsum board manufacturing processes and, more particularly, to a system and method for detecting a lump of hardened slurry within a gypsum board during its manufacture.

In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Pat. No. 5,320,677, for example. Typically, such gypsum-containing cementitious products are made by preparing a mixture of calcined gypsum (calcium sulfate alpha or beta hemihydrate and/or calcium sulfate anhydrite), water, and other components, as appropriate to form cementitious slurry. The cementitious slurry and desired additives are often blended in a continuous mixer, as described in U.S. Pat. No. 3,359,146, for example.

In a typical gypsum board manufacturing process, gypsum board is produced by uniformly dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material (i.e., the face sheet) supported by a forming table. The foamed slurry is allowed to spread over the advancing face sheet. A second web of cover sheet material (i.e., the back sheet) is applied to cover the foamed slurry and form a sandwich structure of a continuous wallboard preform. The wallboard preform is subjected to forming, such as at a conventional forming assembly, to obtain a desired thickness.

The calcined gypsum reacts with the water in the wallboard preform to form a matrix of crystalline hydrated gypsum or calcium sulfate dihydrate and sets as a conveyor moves the wallboard preform down the manufacturing line. The hydration of the calcined gypsum provides for the formation of an interlocking matrix of set gypsum, thereby imparting strength to the gypsum structure in the gypsum-containing product. The gypsum slurry becomes firm as the crystal matrix forms and holds the desired shape.

After the wallboard preform is cut into segments downstream of the forming assembly at a point along the line where the preform has set sufficiently, the segments are flipped over, dried (e.g., in a kiln) to drive off excess water, and processed to provide the final wallboard product of desired dimensions. The aqueous foam produces air voids in the set gypsum, thereby reducing the density of the finished product relative to a product made using a similar slurry but without foam.

Prior devices and methods for addressing some of the operational problems associated with the production of gypsum wallboard are disclosed in commonly-assigned U.S. Pat. Nos. 5,683,635; 5,643,510; 6,494,609; 6,874,930; 7,007,914; and 7,296,919, which are incorporated by reference. There is a continued need in the art to provide additional solutions to enhance the production of gypsum boards.

For example, in conventional arrangements, the mixer and discharge assembly can be subject to slurry build up within their interior passageways. This slurry build up can occur at places where the slurry is moving locally at a different rate than the surrounding area, such as at the interior boundary wall defining the slurry passageway through a conduit. Slurry which remains in the equipment can set and harden. Eventually, a lump of the set gypsum can break free and travel downstream in the manufacturing process. The lump can cause a manufacturing upset, such as, a paper tear as the lump travels through the forming assembly in a drywall manufacturing application, for example. There is a continued need for techniques for detecting when such a potential process upset condition has occurred.

It will be appreciated that this background description has been created by the inventors to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing a gypsum board. In one embodiment, a system for manufacturing a gypsum board includes a conveyor and a forming assembly.

The conveyor is configured to convey the gypsum board along a machine direction through and past the forming assembly. The conveyor extends along the machine direction and along a cross-machine direction. The cross-machine direction is perpendicular to the machine direction.

The forming assembly is configured to form the gypsum board such that the gypsum board is within a predetermined thickness range. The forming assembly includes a first forming member, a second forming member, an actuator, a vibration sensor, and a controller.

The first and second forming members are arranged in aligned relationship with each other along the machine direction at an intermediate point of the conveyor. The first forming member is movably mounted with respect to the second forming member along a normal axis over a range of travel. The normal axis is perpendicular to the machine direction and the cross-machine direction. The first and second forming members extend along the cross-machine direction such that the gypsum board is disposed within the first and second forming members laterally along the cross-machine direction. The first and second forming members are arranged with respect to the conveyor along the normal axis such that the conveyor is adapted to convey the gypsum board along the machine direction between the first and second forming members along the normal axis to limit a thickness of the gypsum board.

The actuator is configured to selectively move the first forming member with respect to the second forming member over the range of travel along the normal axis such that a height is variably defined between the second forming member and the first forming member along the normal axis. The height is correlated to a thickness of the gypsum board.

The vibration sensor is arranged with respect to one of the first and second forming members to detect the vibration of said forming member. The vibration sensor is configured to generate a vibration signal indicative of an amount of vibration sensed by the vibration sensor.

The controller is in electrical communication with the vibration sensor to receive the vibration signal therefrom. The controller is in operable relationship with the actuator and is programmed to control the actuator to increase the height between the second forming member and the first forming member along the normal axis relative by a predetermined amount in response to the vibration signal satisfying a condition.

In another aspect, the present disclosure describes embodiments of a method of manufacturing a gypsum board. In one embodiment, a method of manufacturing a gypsum board includes conveying the gypsum board along a machine direction through a forming assembly. The gypsum board has a core interposed between a first cover sheet and a second cover sheet. The core comprises an aqueous gypsum slurry. The gypsum board extends along the machine direction and along a cross-machine direction. The cross-machine direction is perpendicular to the machine direction.

The gypsum board is formed to a thickness by positioning first and second forming members of the forming assembly along a normal axis such that the gypsum board is conveyed along the machine direction between the first and second forming members along the normal axis. The normal axis is perpendicular to the machine direction and the cross-machine direction. The first forming member is positioned with respect to the second forming member along the normal axis such that a first height is defined therebetween along the normal axis. The height is correlated to the thickness of the gypsum board

Vibration of at least one of the first forming member and the second forming member is monitored. The height between the first forming member and the second forming member along the normal axis is increased to a second height in response to the vibration satisfying a condition. The second height is greater than the first height.

Further and alternative aspects and features of the disclosed principles will be appreciated from the following detailed description and the accompanying drawings. As will be appreciated, the systems and techniques for manufacturing gypsum boards that are disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a fragmentary, schematic side elevational view of an embodiment of a system for manufacturing a gypsum board made from an aqueous calcined gypsum slurry in the form of a gypsum wallboard manufacturing line which is constructed in accordance with principles of the present disclosure, the system including an embodiment of a forming assembly which is constructed in accordance with principles of the present disclosure and is positioned at a predetermined location along the manufacturing line between a mixer and a cutting station.

FIG. 2 is a top plan view of the system for manufacturing a gypsum board of FIG. 1.

FIG. 3 is a enlarged detail view of the forming assembly of FIG. 1, illustrating first forming member of the forming assembly disposed at a first height in relationship to a second forming member.

FIG. 4 is a view as in FIG. 3, but illustrating the first forming member moved along a normal axis to a second height in relation to the second forming member which is greater than the first height shown in FIG. 3.

FIG. 5 is a flowchart illustrating steps of an embodiment of a method of manufacturing a gypsum board following principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

The present disclosure provides various embodiments of a system and a method for manufacturing a gypsum board that include means and steps for monitoring for a lump of hardened gypsum breaking loose and becoming incorporated into the gypsum board in a way that may cause the occurrence of a potential process upset. For example, the lump of hardened slurry can have a size that is greater than the height separating the forming members of the forming assembly such that the lump tears one or both cover sheets as the lump passes through the forming assembly. A torn cover sheet can permit the aqueous calcined gypsum slurry contained within the gypsum board to flow onto and off the conveyor, creating a situation where the board line must be stopped in order to clean up the spilt slurry.

The present disclosure provides various embodiments of a system and a method for manufacturing a gypsum board that monitor vibration occurring at a forming assembly during the continuous manufacture thereof and automatically increase the height of the passage defined through the forming assembly in response to the vibration satisfying a condition indicative of a hardened lump of slurry present at the forming assembly. The inventors have discovered that the vibration of the forming assembly can increase relative to a baseline vibration value when a hardened lump of slurry that is a size that can cause manufacturing problems (e.g., one that is larger than the height defined by the forming members of the forming assembly (which correlates to the formed thickness of the board)) is either lodged at the forming assembly or passing therethrough.

Embodiments of a forming assembly following principles of the present disclosure can be used online in a continuous manufacturing process to help determine whether a lump of hardened slurry that would otherwise cause a manufacturing process problem (e.g., one that is larger than the height defined between the forming members of the forming assembly that can cause cover sheet tearing) is present within the gypsum board being conveyed through the forming assembly. In embodiments, the forming assembly can be configured to continuously monitor the vibration occurring in at least one of the forming members of the forming assembly. In response to detecting vibration that exceeds a predetermined threshold or satisfies a certain condition that is indicative of the presence of a lump in the gypsum board, an actuator of the forming assembly can increase the relative distance between the forming members to increase the height therebetween, thus permitting the detected lump of hardened slurry to pass through the forming members with a decreased likelihood that the lump tears one or both of the cover sheets as it passes though the forming assembly. In embodiments, the system can be configured to issue an operator alert when a vibration condition indicating the presence of a lump is satisfied.

In embodiments of systems and methods for manufacturing a gypsum board following principles of the present disclosure, a forming assembly can include a first forming member, a second forming member, an actuator, a vibration sensor, and a controller. In embodiments, the controller can be configured to determine whether the presence of a lump within the board at the forming assembly is likely based upon the vibration sensed by the vibration sensor either increasing instantaneously by at least a trigger amount and/or increasing over a base line value by a set amount for a predetermined period of time. In embodiments, the forming assembly can include a plurality of vibration sensors positioned along the first forming member, and the controller can use vibration signal data from all of the vibration sensors in order to monitor the forming assembly.

Embodiments of a system and a method for manufacturing a gypsum board that follow principles of the present disclosure can be used to continuously and automatically measure vibration at a forming assembly in order to detect the occurrence of a piece of hardened gypsum being present within the gypsum board being made at the forming assembly that may cause the gypsum board to suffer from a defect. For example, in embodiments, the continuous values for vibration at the forming assembly generated using principles of the present disclosure can be used to help a line operator avoid the occurrence of one or both cover sheets being torn by a hardened lump of gypsum passing through the forming assembly.

In embodiments, the aqueous calcined gypsum slurry can be any conventional slurry, for example any slurry commonly used to produce gypsum wallboard, acoustical panels including, for example, acoustical panels described in U.S. Patent Application Publication No. 2004/0231916, or portland cement board, for example. As such, the slurry can optionally further comprise any other additives that are commonly used in the production of gypsum products. Such additives include structural additives, including mineral wool, continuous or chopped glass fibers (also referred to as fiberglass), perlite, clay, vermiculite, calcium carbonate, polyester, and paper fiber, as well as chemical additives, such as aqueous foam/foaming agents, fillers, accelerators, sugar, enhancing agents such as phosphates, phosphonates, borates and the like, retarders, binders (e.g., starch and latex), colorants, fungicides, biocides, hydrophobic agent, such as a silicone-based material (e.g., a silane, siloxane, or silicone-resin matrix), and the like. Examples of the use of some of these and other additives are described, for instance, in U.S. Pat. Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

Non-limiting examples of cementitious materials suitable for use in embodiments following principles of the present disclosure include water-soluble calcium sulfate anhydrite, calcium sulfate a-hemihydrate, calcium sulfate β-hemihydrate, natural, synthetic or chemically modified calcium sulfate hemihydrate, calcium sulfate dihydrate (“gypsum,” “set gypsum,” or “hydrated gypsum”), and mixtures thereof. In one aspect, the material desirably comprises calcined gypsum (sometimes referred to as, “stucco”), such as in the form of calcium sulfate alpha hemihydrate, calcium sulfate beta hemihydrate, and/or calcium sulfate anhydrite. The calcined gypsum can be fibrous in some embodiments and nonfibrous in other embodiments. In embodiments, the calcined gypsum can include at least about 50% beta calcium sulfate hemihydrate. In other embodiments, the calcined gypsum can include at least about 86% beta calcium sulfate hemihydrate. The weight ratio of water to calcined gypsum in the slurry can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as, in a range between about 1:6 and about 1:1, e.g., about 2:3.

In embodiments, a gypsum board made according to principles of the present disclosure can include at least one layer made from slurry with a formulation that is different from the formulation of the slurry used to make a core layer of the gypsum board. In embodiments, the formulation of the slurry that forms the concentrated layer can include a strengthening additive in an amount that is more concentrated (by weight percentage) than the amount of the same strengthening additive in the formulation of the core slurry. In embodiments, the concentrated layer can comprise a “concentrated layer” that is made using techniques and cementitious slurry formulations as described in U.S. Patent Application Nos. 62/184,060, filed Jun. 24, 2015; 62/290,361, filed Feb. 2, 2016; Ser. No. 15/186,176, filed Jun. 17, 2016; Ser. No. 15/186,212, filed Jun. 17, 2016; Ser. No. 15/186,232, filed Jun. 17, 2016; and Ser. No. 15/186,257, filed Jun. 17, 2016, which are incorporated herein by reference in their entireties.

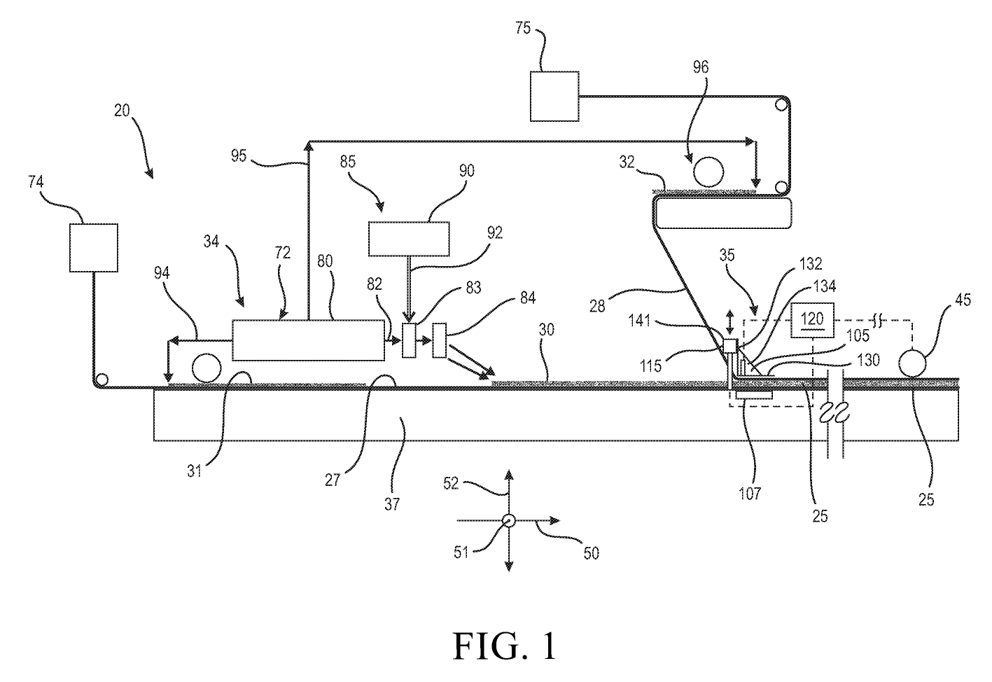

Turning now to the Figures, an embodiment of a system 20 for manufacturing a gypsum board 25 constructed according to principles of the present disclosure is shown in FIG. 1. The illustrated gypsum board 25 includes a first cover sheet 27, a second cover sheet 28, and a gypsum core 30. The gypsum core 30 is interposed between the first and second cover sheets 27, 28.

The illustrated system 20 includes a wet end system 34, a forming assembly 35, a conveyor 37, and a cutting station 45. The wet end system 34 and the forming assembly 35 are configured to mix and assemble constituent materials together such that a continuous gypsum board 25 having a predetermined nominal thickness is fed from the forming assembly 35 along the conveyor 37 in a machine direction 50 toward the cutting station 45. The conveyor 37 is adapted to move the gypsum board 25 along a machine direction 50 through the forming assembly 35 and the cutting station 45 toward a kiln. The conveyor 37 extends along the machine direction 50 and along a cross-machine direction 51. The cross-machine direction 51 is perpendicular to the machine direction 50. The gypsum board 25 has a pair of edges extending along the machine direction 50. The cutting station 45 is adapted to periodically cut the gypsum board 25 into board segments of a predetermined length (measured along the machine direction 50).

In the illustrated embodiment, the wet end system 34 is configured as a gypsum wallboard wet end system. The wet end system 34 can include any suitable equipment adapted to mix and/or assemble the constituent materials forming the gypsum board 25. In the illustrated embodiment, the wet end system 34 includes a gypsum slurry mixing and dispensing system 72 adapted to produce an aqueous gypsum slurry that forms the core 30 of the gypsum board 25. In embodiments, the core slurry 30 includes at least water and calcined gypsum (commonly referred to as “stucco”). In embodiments, the core slurry 30 comprises a foamed calcined gypsum slurry that includes, water, stucco, and an aqueous foam. In embodiments, the core slurry 30 can be formed in any suitable manner.

A first roll 74 of cover sheet material is configured to be selectively dispensed such that the first cover sheet 27 is dispensed from the first roll 74 upstream of the slurry mixing and dispensing system 72 and conveyed upon a forming table of the conveyor 37 that extends between the slurry mixer and dispensing system 72 and the forming assembly 35. A second roll 75 of cover sheet material is configured to be selectively dispensed such that the second cover sheet 28 is dispensed from the second roll 75 at a position between the slurry mixing and dispensing system 72 and the forming assembly 35 over the first cover sheet 27 and the gypsum core slurry 30 dispensed from the slurry mixing and dispensing system 72. Gypsum board products are typically formed “face down” such that the first cover sheet 27 dispensed from the first roll 74 traveling over the forming table serves as the “face” cover sheet 27 of the finished gypsum board 25.

In embodiments, the wet end system 34 can include a cover sheet folding system adapted to fold each of the edges of the face cover sheet 27 to define an edge wall and a connection flap at a point upstream of the forming assembly 35 for use in connecting the face cover sheet 27 and the rear cover sheet 28. In embodiments, the cover sheet folding system can include any suitable equipment known to those skilled in the art for such purpose. The cover sheet folding system can use creases disposed adjacent each edge of the face cover sheet 27 to facilitate the formation of the board edge walls and the connection flaps as understood by one skilled in the art. In embodiments, the creases can be formed adjacent each lateral edge of the cover sheet 27 using any suitable creasing equipment and techniques as known to those skilled in the art.

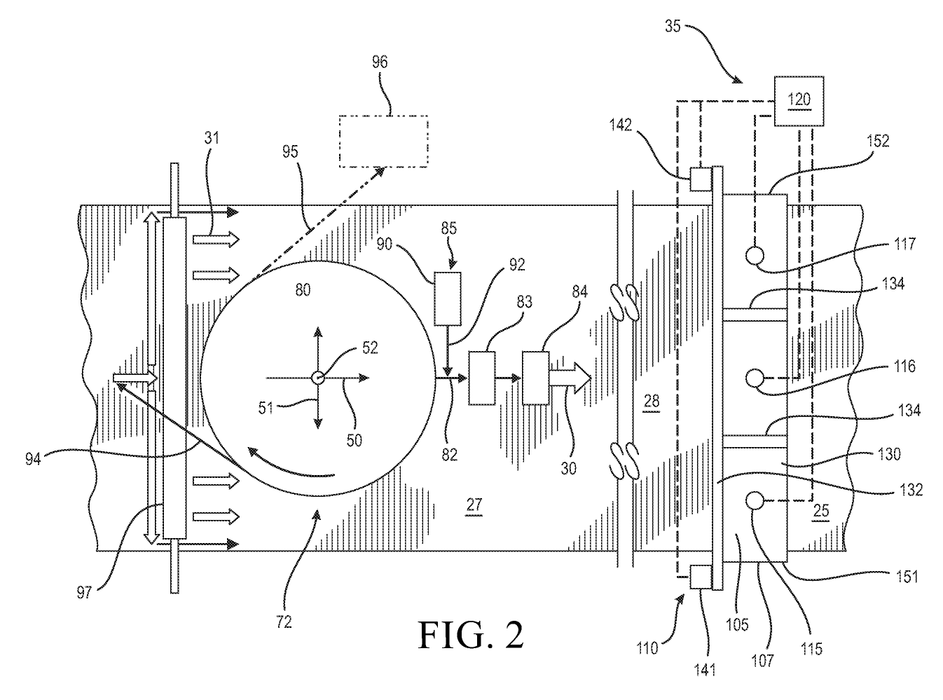

Referring to FIGS. 1 and 2, in the illustrated embodiment, the slurry mixing and dispensing system 72 includes a mixer 80, a main discharge conduit 82, and a foam injection system 85. The mixer 80 is adapted to agitate water and a cementitious material (e.g., stucco) to form the core slurry of the gypsum board 25. The mixer 80 is in fluid communication with the main discharge conduit 82. Both the water and the calcined gypsum can be respectively supplied to the mixer 80 via one or more inlets as is known in the art. In embodiments, any other suitable gypsum slurry additive can be supplied to the mixer 80 as is known in the art of manufacturing gypsum products.

Any suitable mixer (e.g., a pin mixer) can be used in the slurry mixing and dispensing system 72. In embodiments, the mixer 80 can be a suitable, commercially-available mixer, as is known in the gypsum board manufacturing art, such as, for example, one available from Gypsum Technologies Inc. or John Broeders Machine, both of Ontario, Canada.

In embodiments, the mixer 80 defines a mixing chamber in which is disposed a rotatable agitator. The agitator can include a radially extending disc to which is attached a generally vertical drive shaft positioned along a normal axis 52, which is perpendicular to both the machine direction 50 and the cross-machine direction 51 (see FIG. 2). The drive shaft can extend through the upper wall of the mixer 80. The drive shaft can be connected to a conventional drive source, such as, a motor, for example, for rotating the drive shaft at a suitable speed (e.g., 275-300 rpm) appropriate for rotating the agitator to mix the contents of the mixing chamber of the mixer 80. This rotation directs the resulting aqueous slurry in a generally centrifugal direction, such as in a clockwise outward spiral, as shown in FIG. 2. It should be appreciated that this discussion of an agitator is meant only to indicate the basic principles of agitators commonly employed in gypsum slurry mixing chambers known in the art. Alternative agitator designs, including those employing pins, paddles, plows, rings, etc., are contemplated.

The main discharge conduit 82 is in fluid communication with the mixer 80 and is configured to deliver a main flow of the core slurry 30 from the mixer 80 downstream to a further manufacturing station (e.g., the forming assembly 35, as shown in FIG. 1). The core slurry 30 can be discharged from the main discharge conduit 82 in an outlet flow direction substantially along the machine direction 50. In the illustrated embodiment, which can be used to produce a cementitious board in the form of a gypsum board, the main discharge conduit 82 is adapted to deposit the core slurry 30 upon the first cover sheet 27 advancing in the machine direction 50 at a location where the first cover sheet 27 is supported by a forming table of the conveyor 37 extending between the slurry mixing and dispensing system 72 and the forming assembly 35.

The main discharge conduit 82 can be made from any suitable material and can have different shapes, including any suitable conventional discharge conduit known to one skilled in the art. In some embodiments, the discharge conduit can comprise a flexible conduit. In embodiments, the main discharge conduit 82 can comprise any suitable discharge conduit component as will be appreciated by one skilled in the art, such as a foam injection body of the foam injection system 85, a flow-modifying element, and a slurry distributor, for example.

In embodiments, one or more flow-modifying elements 83 can be associated with the discharge conduit 82 and adapted to modify the flow of the core slurry 30 discharged from the mixer 80 through the discharge conduit 82. In embodiments, the flow-modifying element 83 is disposed downstream of a foam injection body which is part of the discharge conduit 82 and the aqueous foam supply conduit relative to a flow direction of the flow of cementitious slurry from the mixer 80 through the discharge conduit 82. The flow-modifying element(s) 83 can be used to control an operating characteristic of the flow of the core slurry 30 moving through the discharge conduit 82. Examples of suitable flow-modifying elements 83 include volume restrictors, pressure reducers, constrictor valves, canisters etc., including those described in U.S. Pat. Nos. 6,494,609; 6,874,930; 7,007,914; and 7,296,919, for example.

In embodiments, the main discharge conduit 82 can include a slurry distributor 84 which can be any suitable terminal portion of a conventional discharge conduit, such as a length of conduit in the form of a flexible hose or a component commonly referred to as a “boot.” In embodiments, the boot can be in the form of a multi-leg discharge boot.

In yet other embodiments, the slurry distributor 84 of the discharge conduit 82 can be similar to one as shown and described in U.S. Patent Application Publication Nos. 2012/0168527; 2012/0170403; 2013/0098268; 2013/0099027; 2013/0099418; 2013/0100759; 2013/0216717; 2013/0233880; and 2013/0308411, for example. In some of such embodiments, the discharge conduit 82 can include suitable components for splitting a main flow of the core slurry 30 from the mixer 80 into two flows which are re-combined in the slurry distributor.

In embodiments, the foam injection system 85 is arranged with at least one of the mixer 80 and the slurry discharge conduit 82. The foam injection system 85 can include a foam source 90 (e.g., such as a foam generation system configured as known in the art), a foam supply conduit 92, and a suitable foam injection body.

In embodiments, any suitable foam source 90 can be used. Preferably, the aqueous foam is produced in a continuous manner in which a stream of a mix of foaming agent and water is directed to a foam generator, and a stream of the resultant aqueous foam leaves the generator and is directed to and mixed with the gypsum slurry. In embodiments, any suitable foaming agent can be used. Some examples of suitable foaming agents are described in U.S. Pat. Nos. 5,683,635 and 5,643,510, for example.

In embodiments, the aqueous foam supply conduit 92 can be in fluid communication with at least one of the mixer 80 and the discharge conduit 82. An aqueous foam from the foam source 90 can be added to the constituent materials through the foam supply conduit 92 at any suitable location downstream of the mixer 80 in the discharge conduit 82 and/or in the mixer 80 itself to form a foamed gypsum slurry.

In embodiments, the foam injection body comprises a part of at least one of the mixer 80 and the slurry discharge conduit 82. For example, in embodiments, the aqueous foam supply conduit 92 has a manifold-type arrangement for supplying foam to a number of foam injection ports within the foam injection body, which can be in the form of an injection ring or block, associated with the discharge conduit 82, such as is described in U.S. Pat. No. 6,874,930, for example. In embodiments, a flow-modifying element 83 is disposed downstream of the foam injection body and the aqueous foam supply conduit 92 relative to a flow direction of the flow of core slurry 30 from the mixer 80 through the discharge conduit 82.

In embodiments, the foam supply conduit 92 can be in fluid communication with the discharge conduit 82 and one or more secondary foam supply conduits can be provided which are in fluid communication with the mixer 80. In yet other embodiments, the aqueous foam supply conduit(s) 92 can be in fluid communication with the mixer alone 80. In embodiments, the foam injection body can be part of a transition piece (commonly referred to as a “gate”) mounted to the outlet of the mixer 80. As will be appreciated by those skilled in the art, the means for introducing aqueous foam into the cementitious slurry in the slurry mixing and dispensing assembly 72, including its relative location in the assembly, can be varied and/or optimized to provide a uniform dispersion of aqueous foam in the core slurry 30 to produce board that is fit for its intended purpose.

In embodiments, one or both of the cover sheets 27, 28 of the gypsum board 25 can be treated with a relatively denser layer 31, 32 of gypsum slurry (relative to the core slurry 30 from which the board core is made), often referred to as a “skim coat” in the art, if desired. To that end, in embodiments, the mixer 80 can include an auxiliary conduit 94 that is adapted to deposit a stream of dense aqueous cementitious slurry 31 that is relatively denser than the core slurry 30 deposited from the discharge conduit 82.

In embodiments, an auxiliary conduit 95 can be provided for depositing a skim coat layer 32 to the back cover sheet 28. For example, in embodiments, the mixer 80 can direct a flow of aqueous calcined gypsum slurry through an auxiliary conduit 95 (i.e., a “back skim coat stream”) that is relatively denser than the main flow of the foamed core slurry 30 dispensed from the main discharge conduit 82. A back skim coat station 96 can include suitable equipment for applying the back skim coat, such as, for example, a back skim coat roller disposed over a support element such that the second cover sheet 28 being dispensed from the second roll 75 is disposed therebetween. The auxiliary conduit 95 can deposit the back skim coat stream 31 upon the moving second cover sheet 28 upstream (in the direction of movement of the second cover sheet 28) of the back skim coat roller that is adapted to apply a skim coat layer to the second cover sheet 28 being dispensed from the second roll 75 as is known in the art.

In embodiments, a suitable front skim coat stream of gypsum slurry 31 can be produced that has a density which is greater than that of the core slurry 30 being dispensed from the main discharge conduit 82. In embodiments, the slurry mixing and dispensing system 72 can include any suitable arrangement of skim coating equipment to apply the front skim coat 31 to the first cover sheet 27, including suitable equipment to produce a gypsum board having hard edges, as one skilled in the art will readily understand and such as the skim coat roller 97 shown in FIG. 2.

In other embodiments, a different source of slurry can be used to form the skim coat streams 31, 32. In at least some embodiments, the gypsum board 25 can include a layer made from a slurry with a formulation that is different from the core slurry 30 discharged from the main discharge conduit 82. In at least some embodiments, the layer made from a slurry with a formulation that is different from the core slurry 30 discharged from the main discharge conduit 82 can be produced using a different mixer.

In other embodiments, one or more separate auxiliary conduits can be connected to the mixer 80 to deliver one or more separate streams to the face cover sheet 27. Other suitable equipment (such as auxiliary mixers) can be provided in the auxiliary conduits to help make the slurry therein denser, such as by mechanically breaking up foam in the slurry and/or by chemically breaking up the foam through use of a suitable de-foaming agent inserted into the auxiliary conduit(s) through a suitable inlet. In other embodiments, an auxiliary conduit can direct slurry from the mixer 80 into a second mixer and/or include a suitable inlet for incorporating at least one enhancing additive therein to form a strengthened slurry having at least one ingredient which is more concentrated than in the core slurry 30 to form a slurry suitable for use as a concentrated layer and/or as edge layer(s).

In embodiments, the formulation and production of the slurry 31 can be similar in other respects to the formulation and production of the “concentrated layer” as described in U.S. Patent Application Nos. 62/184,060, filed Jun. 24, 2015; 62/290,361, filed Feb. 2, 2016; Ser. No. 15/186,176, filed Jun. 17, 2016; Ser. No. 15/186,212, filed Jun. 17, 2016; Ser. No. 15/186,232, filed Jun. 17, 2016; and Ser. No. 15/186,257, filed Jun. 17, 2016. In embodiments, the formulation and production of the core slurry 30 can be similar in other respects to the formulation and production of the slurry used to produce the “board core” as described in U.S. Patent Application Nos. 62/184,060, filed Jun. 24, 2015; 62/290,361, filed Feb. 2, 2016; Ser. No. 15/186,176, filed Jun. 17, 2016; Ser. No. 15/186,212, filed Jun. 17, 2016; Ser. No. 15/186,232, filed Jun. 17, 2016; and Ser. No. 15/186,257, filed Jun. 17, 2016.

Referring to FIG. 1, the forming assembly 35 is adapted to form the gypsum board 25 such that the gypsum board 25 is within a predetermined thickness range. The forming assembly 35 can comprise any equipment suitable for its intended purpose as is known in the art. For example, in embodiments, the forming assembly 35 can include a pair of forming plates in spaced relationship to each other along the normal axis 52. The cementitious board 25 passes through the vertically spaced-apart forming plates/rolls to determine the thickness of the cementitious board 25. The forming plate can be adjustably moved with respect to each other to further refine the thickness of the gypsum board 25 (and when the nominal thickness of the board is changed, e.g., when changing from half-inch thick to ⅝-inch or ⅜-inch thick board, for example) Equipment can be provided that is configured to apply an adhesive to secure the back cover sheet 28 to the face cover sheet 27.

The conveyor 37 is adapted to convey the gypsum board 25 along the machine direction 50 through from the forming assembly 35 and the cutting station 45. The conveyor 37 is configured to support the gypsum board 25 such that the first cover sheet 27 of the gypsum board 25 is resting upon the conveyor 37. The conveyor 37 extends along the machine direction 50 and along the cross-machine direction 51 which is perpendicular to the machine direction 50. The conveyor 37 is adapted to convey the gypsum board 25 at a line speed along the machine direction 50. In embodiments, the conveyor 37 can be configured such that the line speed can be varied (e.g. to increase/decrease the rate of production of the gypsum board 25 and/or to change the thickness of the board being produced, such as when changing from making gypsum board that is nominally a half inch thick to board that is nominally ⅝-inch thick or vice-versa).

The conveyor 37 can be configured such that the edges of the gypsum board 25 extend in substantially parallel relationship with the machine direction 50. will be appreciated that the conveyor 37 is shown in fragmented form and a portion thereof has been removed for ease of illustration of the cutting station 45. In embodiments, the conveyor 37 is configured such that it has a length, measured along the machine direction 50, sufficient to allow the slurry of the gypsum board 25 to adequately set before reaching the cutting station 45 such that the gypsum board 25 can be cut cleanly.

The conveyor 37 can comprise any equipment suitable for its intended purpose as is known in the art. In the illustrated embodiment, the conveyor 37 includes a plurality of support members that define a support surface. In the illustrated embodiment, the support members of the conveyor 37 comprise rollers that are journaled for rotation. In embodiments, at least a portion of the conveyor 37 can be equipped with a forming belt in overlying relationship to the rollers to help support the cementitious board 25 spanning between the rollers 120 and to help produce a gypsum board 25 having a face cover sheet 27 with a smooth surface.

Referring to FIG. 1, the system 20 for manufacturing a gypsum board 25 includes an embodiment of a forming assembly 35 constructed according to principles of the present disclosure. The forming assembly 35 is configured to form the gypsum board 25 such that the gypsum board 25 is within a predetermined thickness range. In embodiments, the forming assembly 35 can be configured to detect vibration at the forming assembly during the continuous manufacture of gypsum board that is indicative of a hardened lump of slurry that may cause manufacturing process problems being lodged at or passing through the forming assembly. In embodiments, the forming assembly 35 can be configured, in response to detecting such a condition, to automatically increase the height distance between first and second forming members of the forming assembly to allow the hardened lump of slurry to pass through the forming assembly to reduce the incidence of the hardened lump of slurry causing a process upset situation (that may cause the boardline to be stopped in order to correct the upset).

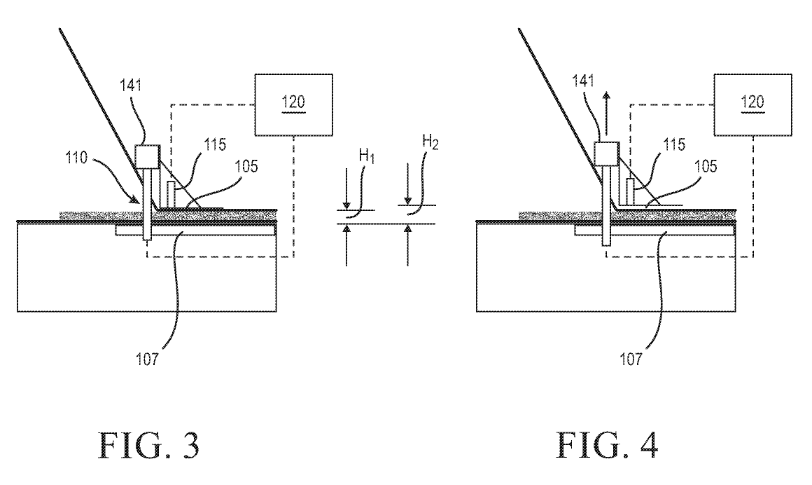

Referring to FIGS. 2 and 3, the illustrated embodiment of the forming assembly 35 includes a first forming member 105, a second forming member 107 (see FIGS. 1 and 3), an actuator system 110, a plurality of vibration sensors 115, 116, 117, and a controller 120. The first forming member 105 is movably mounted with respect to the second forming member 107 along the normal axis 52 over a range of travel. The actuator system 110 is configured to selectively move the first forming member 105 relative to the second forming member 107 over the range of travel along the normal axis 52. The vibration sensors 115, 116, 117 are mounted to the first forming member 105 and are configured to detect the vibration of the first forming member 105. The controller 120 is in electrical communication with the vibration sensors 115, 116, 117, to respective receive therefrom a vibration signal indicative of the vibration sensed by the respective vibration sensor 115, 1116, 117. The controller 120 is in operable arrangement with the actuator system 110 and is configured to control the actuator system to raise the height of the first forming member 105 relative to the second forming member 107 form a first height H₁ (see FIG. 3) to an increased height H₂ (see FIG. 4) in response to the vibration signal data received from the vibration sensors 115, 116, 117 satisfying a predetermined condition.

Referring to FIGS. 1 and 2, the first and second forming members 105, 107 are arranged in aligned relationship with each other along the machine direction 50 at an intermediate point of the conveyor 37. In embodiments, the first and second forming members 105, 107 can have different lengths, as measured along the machine direction 50. In embodiments, the first and second forming members 105, 107 are arranged in aligned relationship with each other along the machine direction 50 in that at least a portion of one 105 of the forming members 105, 107 is in overlapping relationship with the other 107 of the forming members 105, 107 along the machine direction 50.

The first and second forming members 105, 107 extend along the cross-machine direction 51 such that the gypsum board 25 is disposed within the first and second forming members 105, 107 laterally along the cross-machine direction 51. The first and second forming members 105, 107 are arranged with respect to the conveyor 37 along the normal axis 52 such that the conveyor 37 is adapted to convey the gypsum board 25 along the machine direction 50 between the first and second forming members 105, 107 along the normal axis 52 to limit a thickness of the gypsum board 25. In embodiments, the gypsum board 25 is pressed between the first and second forming members 105, 107 such that the thickness of the gypsum board 25, measured along the normal axis 52, is limited to the height distance separating the first and second forming members 105, 107 along the normal axis 52.

Referring to FIGS. 1 and 2, the first forming member 105 is disposed along the normal axis 52 over the conveyor 37. In the illustrated embodiment, the first forming member 105 comprises a forming plate. The first forming member 105 includes a plate 130, an upright support 132 (sometimes referred to as a strongback), and a plurality of triangular-shaped gussets 134 extending between the plate 130 and the upright support 132. Referring to FIG. 2, the gussets 134 are disposed in spaced relationship to each other along the cross-machine direction 51. In other embodiments, the number of gussets 134 and/or the spacing of the gussets 134 along the cross-machine direction 51 can be varied.

The second forming member 107 is disposed along the normal axis 52 in aligned relationship with the conveyor 37. In embodiments, the second forming member 107 comprises a component of the conveyor 37. In embodiments, the second forming member 107 comprises a substantially flat plate that is longer along the machine direction 50 than the first forming member 105 (see, e.g., FIG. 3).

In embodiments, the first and second forming members 105, 107 can comprise any suitable forming member as will be appreciated by one skilled in the art. In embodiments, any suitable forming plate can be used in the forming assembly 35, including commercially-available forming plates, such as those available from Gypsum Technologies Inc. or John Broeders Machine, both of Ontario, Canada, for example.

Referring to FIGS. 1 and 2, in embodiments, the actuator system 110 includes at least one actuator 141 that is configured to selectively move the first forming member 105 with respect to the second forming member 107 over the range of travel along the normal axis 52 such that a height is variably defined between the second forming member 107 and the first forming member 105 along the normal axis 52. The height is correlated to a thickness of the gypsum board 25.

The illustrated actuator system 110 includes a pair of actuators 141, 142. The actuators 141, 142 are respectively attached to each side of the conveyor 37 and each end of the first forming member 105. Each of the actuators 141, 142 is in operable arrangement with the controller 120 such that the controller 120 can selectively operate the actuators 141, 142 to reciprocally move the first forming member 105 relative to the second forming member 107 along the normal axis 52 over the range of travel suitable for the intended product thicknesses of the gypsum board being produced on the boardline and the desired increased height in the situation where an elevated vibration condition is detected.

In embodiments, the actuators 141, 142 can have a different mounting arrangement. In embodiments, a single actuator or a different number of actuators can be used.

In embodiments, any suitable actuator that can reciprocally move the first forming member 105 relative to the second forming member 107 along the normal axis 52 over the desired range of travel can be used. For example, each actuator can comprise a suitable linear actuator (as shown in the illustrated embodiment of FIGS. 3 and 4, e.g.). The linear actuator can be powered by any suitable source (e.g., electrical, pneumatic, hydraulic, etc.).

Referring to FIG. 1, in embodiments, the forming assembly 35 includes at least one vibration sensor 115 arranged with respect to one of the first and second forming members 105, 107 to detect the vibration of said forming member 105, 107. In embodiments, the forming assembly 35 includes a plurality of vibration sensors 115, 116, 117 (see FIG. 2). Each of the plurality of vibration sensors 115, 116, 117 is configured to generate a vibration signal indicative of an amount of vibration sensed by the respective vibration sensor 115, 116, 117.

Referring to FIG. 2, in the illustrated embodiment, the forming assembly 35 comprises three vibration sensors. Each of the plurality of vibration sensors 115, 116, 117 is mounted to the first forming member 105. Each of the plurality of vibration sensors 115, 116, 117 is in electrical communication with the controller 120. In other embodiments, the number of vibration sensors 115, 116, 117 can be varied.

The vibration sensors 115, 116, 117 are mounted to the first forming member 105 such that the vibration sensors 115, 116, 117 are in spaced relationship to each other along the cross-machine direction 51. In the illustrated embodiment, the vibration sensors 115, 116, 117 are in substantially equal spaced relationship to each other along the cross-machine direction and from each edge 151, 152 of the first forming member 105. In other embodiments, the spacing of at least one of the vibration sensors 115, 116, 117 can be varied. For example, in embodiments, two of the vibration sensors 115, 117 can be positioned relatively close to a respective edge 151, 152 of the first forming member 105 (within twelve inches from the respective edge along the cross-machine direction 51, for example) and the third vibration sensor 116 can be placed substantially at the midpoint of the first forming member 105 along the cross-machine direction 51.

In the illustrated embodiment, the vibration sensors 115, 116, 117 have the same construction and functionality. In other embodiments, at least one vibration sensor can have a construction and/or functionality that is different from at least one other vibration sensor included in the forming assembly.

In embodiments, any suitable vibration sensor can be used, such as a suitable microelectromechanical system (MEMS) type. In embodiments, any suitable measuring range (e.g., 0-25 RMS), frequency range (e.g., 10-1000 Hz), type of sensor (e.g., MEMS), and number of measurement axes (e.g., one axis) can be selected according to the vibration conditions contemplated in using the forming assembly for its intended purpose of manufacturing gypsum board. For example, in embodiments, the vibration sensor can be a commercially-available vibration sensor, such as a vibration sensor commercially-available as Model No. VKV021 from IFM Efector, Inc., of Malvern, Pa.

In embodiments, the vibration sensor can include a magnet mount for mounting the vibration sensor to the forming member via a magnetic connection. The magnetic mount can allow an operator to readily reposition the vibration sensor at another location on the forming member along the cross-machine direction 51 and/or the machine direction 50.

Referring to FIG. 2, the controller 120 is in electrical communication with each of the vibration sensors 115, 116, 117 to receive the respective vibration signal therefrom. The controller 120 is in operable relationship with each actuator 141, 142 and is programmed to control the actuators 141, 142 to increase the height between the second forming member 107 and the first forming member 105 along the normal axis 52 relative by a predetermined amount in response to at least one of the vibration signals satisfying a trigger condition. In embodiments, the height increase can be any suitable value that is suitable for the intended purpose of permitting the hazard to pass through the forming assembly 35 without causing damage to the board 25 sufficient to cause a process upset.

In embodiments, the controller 120 can be any suitable controller capable of carrying out the desired steps and functions described herein for the operation of the forming assembly 35. In embodiments, the controller 120 can include a processor and a non-transitory computer readable medium bearing a vibration monitoring application. The processor is in communication with the vibration sensors 115, 116, 117 to receive the vibration signals therefrom. The processor of the controller 120 is programmed with the vibration monitoring application. In embodiments, the controller 120 is in operable arrangement with the actuator system 110 to selectively vary the height separating the first forming member 105 and the second forming member 107 along the normal axis 52 based upon a control setting generated by the vibration monitoring application using the vibration signals received from the vibration sensors 115, 116, 117.

In embodiments, the controller 120 can include a user input and/or interface device (e.g. a human-machine interface (HMI)) having one or more user-actuated mechanisms (e.g., one or more push buttons, slide bars, rotatable knobs, a keyboard, and a mouse) adapted to generate one or more user actuated input control signals. In embodiments, the controller 120 can be configured to include one or more other user-activated mechanisms to provide various other control functions for the forming assembly 35 and other components of the system 20, as will be appreciated by one skilled in the art. The controller 120 can include a display device adapted to display a graphical user interface. The graphical user interface can be configured to function as both a user input device and a display device in embodiments. In embodiments, the display device can comprise a touch screen device adapted to receive input signals from a user touching different parts of the display screen. In embodiments, the controller 120 can be in the form of a smart phone, a tablet, a personal digital assistant (e.g., a wireless, mobile device), a laptop computer, a desktop computer, or other type of device. In embodiments, the controller 120 and the processor can comprise the same device or be formed from a set of equipment.

In embodiments, the processor can be configured to receive input signals from the controller 120, to send input control signals to the controller 120, and/or to send output information to the controller 120. The processor is in operable arrangement with the non-transitory computer-readable medium to execute the vibration monitoring application contained thereon. The processor can be in operable arrangement with a display device to selectively display output information from the vibration monitoring application and/or to receive input information from a graphical user interface displayed by the display device.

In embodiments, the processor can comprise any suitable computing device, such as, a microprocessor, a mainframe computer, a digital signal processor, a portable computing device, a personal organizer, a device controller, a logic device (e.g., a programmable logic device configured to perform processing functions), a digital signal processing (DSP) device, or a computational engine within an appliance. In embodiments, the processor also includes one or more additional input devices (e.g., a keyboard and a mouse).

The processor can have one or more memory devices associated therewith to store data and information. The one or more memory devices can include any suitable type, including volatile and non-volatile memory devices, such as RAM (Random Access Memory), ROM (Read-Only Memory), EEPROM (Electrically-Erasable Programmable Read-Only Memory), flash memory, etc. In one embodiment, the processor is adapted to execute programming stored upon a non-transitory computer readable medium to perform various methods, processes, and modes of operations in a manner following principles of the present disclosure.

In embodiments, the non-transitory computer readable medium can contain a vibration monitoring application that is configured to implement an embodiment of a method for manufacturing gypsum board according to principles of the present disclosure. In embodiments, the vibration monitoring application includes a graphical user interface that can be displayed by the display device. The graphical user interface can be used to facilitate the inputting of commands and data by a user to the vibration monitoring application and to display outputs generated by the vibration monitoring application.

The vibration monitoring application can be stored upon any suitable computer-readable storage medium. For example, in embodiments, a vibration monitoring application following principles of the present disclosure can be stored upon a hard drive, floppy disk, CD-ROM drive, tape drive, zip drive, flash drive, optical storage device, magnetic storage device, and the like.

In embodiments, the controller 120 is programmed via the vibration monitoring application to perform a vibration computation periodically (e.g., every two seconds). During each vibration computation, the current vibration indicated by the vibration signal of each of the vibration sensors 115, 116, 117 is used to calculate an average vibration for all of the vibration sensors:

average vibration=sum of all vibration values/divided by the number of vibration sensors (Eq. 1).

In embodiments, the controller 120 is programmed via the vibration monitoring application to use the average vibration value it has computed to determine a trip value. In embodiments, the trip value corresponds to a value of the vibration that if it persists for longer than a predetermined period is indicative of a potential hardened lump of slurry being present in the gypsum board at the forming assembly 35 that would otherwise cause a manufacturing process problem. For example, a hardened lump of slurry could be trapped at the mouth leading into and between the first and second forming members 105, 107, causing the vibration of the first forming member 105 to increase and persist at an elevated level over the average vibration while the lump is so caught.

In embodiments, the trip value can be calculated via the vibration monitoring application using a formula including the product of the average vibration and a coefficient. For example, in embodiments, the formula for computing the trip value can be:

trip value=average vibration×coefficient₁, where coefficient₁ is greater than 1 (Eq. 2).

In embodiments, the controller 120 is programmed via the vibration monitoring application to use the average vibration value it has computed to determine a spike trigger value. The spike trigger value corresponds to a value of the vibration that if it exists at the forming assembly is immediately indicative of a potential hardened lump of slurry (or other hazard) being present in the gypsum board 25 at the forming assembly 35.

In embodiments, the spike trigger value can be calculated via the vibration monitoring application using a formula including the product of the average vibration and a coefficient. For example, in embodiments, the formula for computing the spike trigger value can be:

trip value=average vibration×coefficient₂ where coefficient₂ is greater than 1 and greater than coefficient₁ (Eq. 3).

In embodiments, Equations 2 and 3 are configured such that the spike trigger value is greater than the trip value for any given average vibration value. For example, in embodiments, coefficient₁ can be equal to 1.2, and coefficient₂ equal to 1.4. In other embodiments, different formulas can be used to compute the trip value and the spike trigger value.

In the illustrated embodiment, the controller 120 is programmed with a vibration monitoring module configured to: periodically compute (i) an average vibration value based upon all of the vibration signals, (ii) a trip value based upon a first formula including the average vibration value, and (iii) a spike trigger value based upon a second formula including the average vibration value. The spike trigger value is greater than the trip value for the same average vibration value.

The controller 120 is configured to monitor each of the vibration signals from the vibration sensors 115, 116, 117 over time and determine whether the trigger condition is satisfied. In the illustrated embodiment, the trigger condition is satisfied if the vibration signal from any one of the plurality of vibration sensors 115, 116, 117 exceeds the trip value for more than a fixed period of time or exceeds the spike trigger value in effect at any time.

In embodiments, the formula for computing the trip value includes a product of the average vibration value and a first coefficient, and the formula for computing the spike trigger value includes a product of the average vibration value and a second coefficient. In embodiments, the first coefficient and the second coefficient are both greater than 1, and the second coefficient is greater than the first coefficient.

In the illustrated embodiment, the vibration monitoring module is configured to periodically compute (i) the average vibration value, (ii) the trip value, and (iii) the spike trigger value every two seconds, and to determine the trigger condition is satisfied if the vibration signal from any one of the plurality of vibration sensors exceeds the trip value for more than one half of a second. In other embodiments, the period for periodically computing the (i) the average vibration value, (ii) the trip value, and (iii) the spike trigger value can be varied. In embodiments, the length of time over which the trip value must be exceeded by a given vibration sensor 115, 116, 117 in order to satisfy the trigger condition can be varied.

In embodiments, an operator can select an enable function in order to have the controller 120 monitor the vibration data received from the vibration sensors 115, 116, 117 in order to determine whether there is a potential process upset condition. In embodiments, the controller 120 is programmed such that it can be selectively enabled or disabled to monitor the vibration data received from the vibration sensors 115, 116, 117 in order to determine whether the trigger condition is satisfied so as to increase the height of the first forming member 105 relative to the second forming member 107 in response to the condition being satisfied.

In embodiments, the vibration monitoring application includes a timer module that is configured to require a predetermined amount of time to elapse after the enable function is selected before the controller 120 commences determining whether the trigger condition has been satisfied. For example, in embodiments, the timer module can be set so that five minutes elapse after the enable function is selected to allow the operation of the boardline to reach a steady state after startup before the controller monitors via the vibration monitoring application whether the vibration at the forming assembly 35 satisfies a trigger condition that would prompt the controller 120 to operate the actuator system 110 to raise the height of the first forming member 105 relative to the second forming member 107. In embodiments, the timer module can be varied by the operator via the input device of the controller 120 to adjust the time delay (if any) included after selecting the enable function.

In embodiments, the timer module of the vibration monitoring application can be configured to log a time stamp for every instance in which the controller 120 determines that the trigger condition has been satisfied to raise the height of the first forming member 105 relative to the second forming member 107. In embodiments, the vibration monitoring application can be configured to log which one of the vibration sensors 115, 116, 117 caused the trigger condition to be satisfied.

In embodiments, the controller 120 is configured to transmit a command signal to the actuators 141, 142 to operate the actuators 141, 142 to increase the height of the first forming member 105 relative to the second forming member 107 (see FIGS. 3 and 4) in response to the vibration monitoring application determining the trigger condition has been satisfied. In embodiments, the control signal issued by the controller 120 can be routed to a suitable valve system or other power source control mechanism of the actuators 141, 142 to selectively energize the actuators 141, 142 to effect the increase in height.

In embodiments, the controller 120 can be configured via the vibration monitoring application to transmit a return signal to the actuators 141, 142 to decrease the height separating the first forming member 105 and the second forming member 107 along the normal axis 52 to return to the height at which the forming members 105, 107 were before the trigger condition was satisfied. In embodiments, the controller can be configured to transmit the return signal to the actuators 141, 142 to return to the original height separating the first forming member 105 and the second forming member 107 along the normal axis 52 from which the height was increased when the trigger condition was satisfied in response to at least one of: (i) the vibration no longer satisfying the trigger condition and (ii) the elapsing of a predetermined amount of dwell time at the increased height. In embodiments, the controller 120 can be used to operate the actuator system 110 to return the forming assembly 35 to a height that correlates to the nominal thickness of the gypsum board being produced. In embodiments, the controller can be configured to require an operator to input a command to the controller 120 to return to the original height separating the first forming member 105 and the second forming member 107 along the normal axis 52 from which the height was increased when the trigger condition was satisfied.

In embodiments, the controller 120 can be configured via the vibration monitoring application to disable the monitoring function once the trigger condition has been satisfied and the controller 120 transmits the command signal to the actuators 141, 142 to increase the height of the first forming member 105 relative to the second forming member 107 (see FIGS. 3 and 4). The controller 120 can be configured to remain in the disabled mode until an operator inputs an “enable” command to return the controller 120 to the enabled mode. In other embodiments, the controller 120 can be configured via the vibration monitoring application to remain in the mode selected by an operator (e.g., an enabled mode or a disabled mode) until another mode is selected by an operator via an input command to the controller 120.

Referring to FIG. 1, the cutting station 45 is disposed downstream of the forming assembly 35 along the machine direction 50. The cutting station 45 is arranged with respect to the conveyor 37 such that the conveyor 37 carries the gypsum board 25 past the cutting station 45. The cutting station 45 can include a knife configured to periodically cut the gypsum board 25 along the cross-machine direction 51 to define a series of board segments as the cementitious board 25 moves along the machine direction 50 past the cutting station 45. In embodiments, the knife can be a rotary knife as is generally known to those skilled in the art.

In embodiments, the controller 120 can be configured to control the operation of the rotary knife of the cutting station 45. In embodiments, the controller 120 can adjust the rotational speed of the rotary knife based upon the line speed of the board line (as detected by a suitable sensor, for example) to produce board segments of substantially the same length under different line speed conditions.

In embodiments, the system 20 for manufacturing a gypsum board 25 can include other components and stations. For example, in embodiments, the system 20 can include a transfer system, including a board inverter; a kiln; and a bundler and taping station, all downstream of the cutting station 45.

In embodiments of a method of manufacturing a gypsum board following principles of the present disclosure, a forming assembly constructed according to principles of the present disclosure is used to make a gypsum board as discussed herein. In embodiments, a method of manufacturing a gypsum board following principles of the present disclosure can be used with any embodiment of a system for manufacturing a gypsum board according to principles discussed herein.

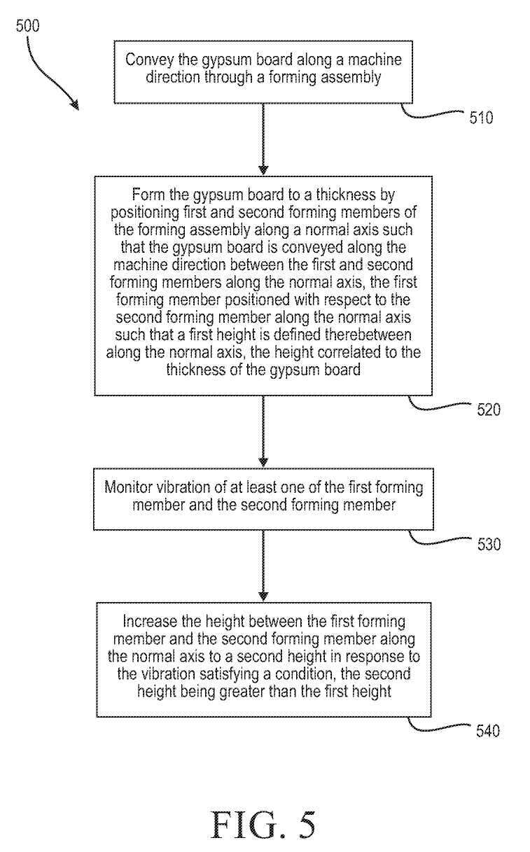

For example, referring to FIG. 5, in embodiments, a method 500 of manufacturing a gypsum board following principles of the present disclosure includes conveying the gypsum board along a machine direction through a forming assembly (step 510). The gypsum board has a core interposed between a first cover sheet and a second cover sheet. The core comprises an aqueous gypsum slurry. The gypsum board extends along the machine direction and along a cross-machine direction. The cross-machine direction is perpendicular to the machine direction.

The gypsum board is formed to a thickness by positioning first and second forming members of the forming assembly with respect to the conveyor along a normal axis such that the gypsum board is conveyed along the machine direction between the first and second forming members along the normal axis (step 520). The normal axis is perpendicular to the machine direction and the cross-machine direction. The first forming member is positioned with respect to the second forming member along the normal axis such that a first height is defined therebetween along the normal axis. The height is correlated to the thickness of the gypsum board

Vibration of at least one of the first forming member and the second forming member is monitored (step 530). The height between the first forming member and the second forming member along the normal axis is increased to a second height in response to the vibration satisfying a condition (step 540). The second height is greater than the first height.

In embodiments, monitoring vibration of at least one of the first forming member and the second forming member is performed by arranging a vibration sensor with respect to one of the first and second forming members to detect the vibration of the forming member. In embodiments, the method further includes transmitting a vibration signal indicative of an amount of vibration sensed by the vibration sensor from the vibration sensor to a controller. The controller can be used to determine whether the condition is satisfied based upon the vibration signal. In embodiments, the vibration signal is transmitted to the controller substantially continuously.

In embodiments, the method further includes using the controller to determine that a predetermined startup time has elapsed during which the gypsum board has been conveyed along the machine direction through the forming assembly before the controller is used to determine whether the condition is satisfied. In this way, the board line is allowed to reach a steady state of operation before commencing the forming assembly vibration monitoring.

In embodiments, the method further includes decreasing the height between the first forming member and the second forming member along the normal axis to the first height in response to at least one of: (i) the vibration no longer satisfies the condition and (ii) the elapsing of a predetermined amount of dwell time. In embodiments, the controller can be used to operate the actuator system to return the forming assembly to a height that correlates to the nominal thickness of the gypsum board being produced.

In embodiments, monitoring vibration of at least one of the first forming member and the second forming member is performed by mounting a plurality of vibration sensors to the first forming member to detect the vibration of said forming member. In embodiments, the method further includes transmitting, from each of the plurality of vibration sensors, a vibration signal indicative of an amount of vibration sensed by each respective vibration sensor to a controller. The controller can be used to determine whether the condition is satisfied based upon at least one of the vibration signals from the plurality of vibration sensors.

In embodiments, the controller can be used to periodically compute: (i) an average vibration value based upon all of the vibration signals and (ii) an trip value based upon a first formula including the average vibration value. The controller can be programmed to monitor each of the vibration signals over time and determine the trigger condition is satisfied once the vibration signal from any one of the plurality of vibration sensors exceeds the trip value for more than a fixed period of time.

In embodiments, the controller can be used to periodically compute a spike trigger value based upon a second formula including the average vibration value. The spike trigger value is greater than the trip value for the same average vibration value. The controller can be programmed to determine the trigger condition is satisfied when the vibration signal from any one of the plurality of vibration sensors exceeds the spike trigger value.

In embodiments, the controller is used to periodically compute (i) the average vibration value, (ii) the trip value, and (iii) the spike trigger value every two seconds. In other embodiments, a different period of time can be used for periodically computing the average vibration value, the trip value, and the spike trigger value.

In embodiments, the controller is programmed to determine the trigger condition is satisfied if the vibration signal from any one of the plurality of vibration sensors exceeds the trip value for more than one half of a second. In other embodiments, a different period of time can be used in combination with the trip value.

In embodiments, the formula for computing the trip value includes a product of the average vibration value and a first coefficient, and the formula for computing the spike trigger value includes a product of the average vibration value and a second coefficient. In embodiments, the first coefficient and the second coefficient both being greater than 1, and the second coefficient is greater than the first coefficient. For example, in embodiments, the first coefficient is 1.2 and the second coefficient is 1.4. Different coefficients can be used in other embodiments.

In embodiments, the method further includes periodically cutting the gypsum board to define a series of board segments as the gypsum board moves along the machine direction past a cutting station. The cutting station is disposed downstream of the forming assembly along the machine direction.

In embodiments, the core of the gypsum board comprises a core layer and a concentrated layer. The core layer is formed from a core slurry comprising at least water and stucco, and the concentrated layer is formed from a concentrated slurry comprising at least water, stucco, and an enhancing additive. The enhancing additive is present in a more concentrated amount by weight percentage in the concentrated slurry than in the core slurry.

In embodiments, the core layer is interposed along a normal axis between the second cover sheet and the concentrated layer. The normal axis is perpendicular to both the machine direction and the cross-machine direction.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing a gypsum board, the system comprising:
a conveyor, the conveyor configured to convey the gypsum board along a machine direction, the conveyor extending along the machine direction and along a cross-machine direction, the cross-machine direction being perpendicular to the machine direction;
a forming assembly, the forming assembly including a first forming member, a second forming member, an actuator, a vibration sensor, and a controller,
the first and second forming members being arranged in aligned relationship with each other along the machine direction at an intermediate point of the conveyor, the first forming member being movably mounted with respect to the second forming member along a normal axis over a range of travel, the normal axis being perpendicular to the machine direction and the cross-machine direction, the first and second forming members extending along the cross-machine direction such that the gypsum board is disposed within the first and second forming members laterally along the cross-machine direction, and the first and second forming members arranged with respect to the conveyor along the normal axis such that the conveyor is adapted to convey the gypsum board along the machine direction between the first and second forming members along the normal axis to limit a thickness of the gypsum board,
the actuator being configured to selectively move the first forming member with respect to the second forming member over the range of travel along the normal axis such that a height is variably defined between the second forming member and the first forming member along the normal axis, the height correlated to the thickness of the gypsum board,
the vibration sensor being arranged with respect to one of the first and second forming members to detect the vibration of said forming member, the vibration sensor configured to generate a vibration signal indicative of an amount of vibration sensed by the vibration sensor,
the controller being in electrical communication with the vibration sensor to receive the vibration signal therefrom, the controller being in operable relationship with the actuator and being programmed to control the actuator to increase the height between the second forming member and the first forming member along the normal axis relative by a predetermined amount in response to the vibration signal satisfying a condition.

2. The system for manufacturing according to claim 1, wherein the first forming member is disposed along the normal axis over the conveyor, and the first forming member comprises a plate.

3. The system for manufacturing according to claim 2, wherein the vibration sensor is mounted to the first forming member.

4. The system for manufacturing according to claim 1, wherein the forming assembly includes a plurality of vibration sensors, each of the plurality of vibration sensors being configured to generate a vibration signal indicative of an amount of vibration sensed by the respective vibration sensor, each of the plurality of vibration sensors being mounted to the first forming member, and wherein the controller is in electrical communication with each of the plurality of vibration sensors to receive the respective vibration signal therefrom, and the controller being programmed to control the actuator to increase the height of the forming member along the normal axis relative to the conveyor by the predetermined amount in response to at least one of the vibration signals from the plurality of vibration sensors satisfying a trigger condition.

5. The system for manufacturing according to claim 4, wherein the first forming member is disposed along the normal axis over the conveyor, and the first forming member comprises a plate.

6. The system for manufacturing according to claim 5, wherein the forming assembly comprises three vibration sensors, the vibration sensors being mounted to the first forming member such that the vibration sensors are in spaced relationship to each other along the cross-machine direction.

7. The system for manufacturing according to claim 5, wherein the controller is programmed with a vibration monitoring module configured to:
periodically compute (i) an average vibration value based upon all of the vibration signals and (ii) a trip value based upon a first formula including the average vibration value,
monitor each of the vibration signals over time,
determine the trigger condition is satisfied if the vibration signal from any one of the plurality of vibration sensors exceeds the trip value for more than a fixed period of time.

8. The system for manufacturing according to claim 7, wherein the vibration monitoring module is configured to:
periodically compute (iii) a spike trigger value based upon a second formula including the average vibration value, the spike trigger value being greater than the trip value for the same average vibration value,
determine the trigger condition is satisfied when the vibration signal from any one of the plurality of vibration sensors exceeds the spike trigger value.

9. The system for manufacturing according to claim 8, wherein the vibration monitoring module is configured to periodically compute (i) the average vibration value, (ii) the trip value, and (iii) the spike trigger value every two seconds, and to determine the trigger condition is satisfied if the vibration signal from any one of the plurality of vibration sensors exceeds the trip value for more than one half of a second.

10. The system for manufacturing according to claim 8, wherein the first formula includes a first product of the average vibration value and a first coefficient, and the second formula includes a second product of the average vibration value and a second coefficient, the first coefficient and the second coefficient both being greater than 1, and the second coefficient being greater than the first coefficient.

11. A method of manufacturing a gypsum board, the method comprising:
conveying the gypsum board along a machine direction through a forming assembly, the gypsum board having a core interposed between a first cover sheet and a second cover sheet, the core comprising an aqueous gypsum slurry, the gypsum board extending along the machine direction and along a cross-machine direction, the cross-machine direction perpendicular to the machine direction;
forming the gypsum board to a thickness by positioning first and second forming members of the forming assembly along a normal axis such that the gypsum board is conveyed along the machine direction between the first and second forming members along the normal axis, the normal axis being perpendicular to the machine direction and the cross-machine direction, the first forming member positioned with respect to the second forming member along the normal axis such that a first height is defined therebetween along the normal axis, the height correlated to the thickness of the gypsum board;
monitoring vibration of at least one of the first forming member and the second forming member;
increasing the height between the first forming member and the second forming member along the normal axis to a second height in response to the vibration satisfying a condition, the second height being greater than the first height.

12. The method of manufacturing according to claim 11, wherein monitoring vibration of at least one of the first forming member and the second forming member is performed by arranging a vibration sensor with respect to one of the first and second forming members to detect the vibration of said forming member, the method further comprising:
transmitting a vibration signal indicative of an amount of vibration sensed by the vibration sensor from the vibration sensor to a controller;
using the controller to determine whether the condition is satisfied based upon the vibration signal.

13. The method of manufacturing according to claim 12, wherein the vibration signal is transmitted to the controller substantially continuously.

14. The method of manufacturing according to claim 12, further comprising:
using the controller to determine that a predetermined startup time has elapsed during which the gypsum board has been conveyed along the machine direction through the forming assembly before the controller is used to determine whether the condition is satisfied.

15. The method of manufacturing according to claim 12, further comprising:
decreasing the height between the first forming member and the second forming member along the normal axis to the first height in response to at least one of (i) the vibration no longer satisfying the condition and (ii) the elapsing of a predetermined amount of dwell time.

16. The method of manufacturing according to claim 11, wherein monitoring vibration of at least one of the first forming member and the second forming member is performed by mounting a plurality of vibration sensors to the first forming member to detect the vibration of said forming member, the method further comprising:
transmitting, from each of the plurality of vibration sensors, a vibration signal indicative of an amount of vibration sensed by each respective vibration sensor to a controller;
using the controller to determine whether the condition is satisfied based upon at least one of the vibration signals from the plurality of vibration sensors.

17. The method of manufacturing according to claim 16, further comprising:
using the controller to
periodically compute (i) an average vibration value based upon all of the vibration signals and (ii) a trip value based upon a first formula including the average vibration value,
monitor each of the vibration signals over time, and
determine the trigger condition is satisfied once the vibration signal from any one of the plurality of vibration sensors exceeds the trip value for more than a fixed period of time.

18. The method of manufacturing according to claim 17, further comprising:
using the controller to
periodically compute (iii) a spike trigger value based upon a second formula including the average vibration value, the spike trigger value being greater than the trip value for the same average vibration value,
determine the trigger condition is satisfied when the vibration signal from any one of the plurality of vibration sensors exceeds the spike trigger value.

19. The method of manufacturing according to claim 17, wherein the controller is used to periodically compute (i) the average vibration value, (ii) the trip value, and (iii) the spike trigger value every two seconds, and to determine the trigger condition is satisfied if the vibration signal from any one of the plurality of vibration sensors exceeds the trip value for more than one half of a second.

20. The method of manufacturing according to claim 17, wherein the first formula includes a first product of the average vibration value and a first coefficient, and the second formula includes a second product of the average vibration value and a second coefficient, the first coefficient and the second coefficient both being greater than 1, and the second coefficient being greater than the first coefficient.
